(19) United States
(12) Patent Application Publication
(10) Pub. No.: US 2017/0215080 A1
(43) Pub. Date: Jul. 27, 2017

(54) METHOD AND DEVICE FOR COMMUNICATING IN UE AND BASE STATION BY USING UNLICENSED FREQUENCY BAND

(71) Applicant: Shanghai Langbo Communication Technology Company Limited, Shanghai (CN)

(72) Inventor: Xiaobo Zhang, Shanghai (CN)

(21) Appl. No.: 15/314,348

(22) PCT Filed: May 22, 2015
(86) PCT No.: PCT/CN2015/079587

§ 371 Date: Nov. 28, 2016

(30) Foreign Application Priority Data
May 29, 2014 (CN) 201410235683.9

(51) Int. Cl. H04W 16/14; H04W 72/04; H04W 72/12; H04L 5/00; H04L 1/18

(52) U.S. Cl. CPC H04W 16/14; H04L 5/0055; H04L 1/1812; H04W 72/1289; H04W 72/0466; H04W 88/02

(57) ABSTRACT

The invention provides a method and a device for communication in a UE and a base station by using an unlicensed frequency band. The UE operates data in a first physical layer in a first sub frame of a first carrier in Step 1, processes a first HARQ_ACK for the data in the first physical layer in Step 2, and operates data in a second physical layer data in a second sub frame of a second carrier in Step 3. The data in the first physical layer and the data in the second physical layer belong to the same HARQ process. The data in the first physical layer is corresponding to a first TB and a second TB, and the data in the second physical layer is corresponding to the first TB or the second TB. The operation and processing are respectively receiving and sending or are respectively sending and receiving. The solution of the present invention is particularly suitable for a DFS scenario in communication using an unlicensed spectrum. Besides, the present invention is compatible with the existing LTE standards as much as possible and has good compatibility.

### BACKGROUND

Technical Field

The present invention is related to a communication scheme using an unlicensed spectrum in a wireless communication system, and more particular to a communication method and device for an unlicensed spectrum based on Long Term Evolution (LTE).

Related Art

In the traditional LTE system of the 3rd Generation Partner Project (3GPP), the data transmission only occurs on the licensed spectrum; however, with the sharp increase in the communication volume, especially in some urban areas, the licensed spectrum may be difficult to meet the demand of the communication volume. A new research topic is discussed in the 62th 3GPP RAN plenary, i.e. the comprehensive research of the unlicensed spectrum (RP-132085). The main purpose is to research the non-standalone deployment of LTE on the unlicensed spectrum, wherein the so-called non-standalone means that the communication on the unlicensed spectrum is required to be associated with the serving cell on the licensed spectrum. An intuitive approach is to reuse the carrier aggregation (CA) in the existing system as much as possible, i.e. the serving cell deployed on the licensed spectrum serves as Pcell (primary cell), and the serving cell deployed on the unlicensed spectrum serves as Scell (secondary cell).

For the unlicensed spectrum, considering the interference level thereof may not be controlled/predicted, the UE (User Equipment) may be configured with more downlink carriers, and a part of carriers is selected from the configured candidate carriers to be used for a transmission of the physical layer data by using a dynamical frequency selection (DFS) manner at the same time. After using the DFS, discontinuous transmission would incour frequently on the same one physical carrier, thereby increasing re-transmission time of a HARQ (hybrid automatic repeat request) and increasing a time delay of the transmission. In order to decrease the time delay of the transmission, a transmission of the physical layer data of the HARQ process may be configured on a plurality of carriers. The traditional LTE defines ten downlink TMs (transmission mode) and two uplink TMs, and for each of the serving cell system equipment, the downlink is semi-statically configured for the UE (the uplink TM may be configured). For the downlink TMs {1, 2, 5, 6, 7} and the uplink TM1, one scheduled physical layer data may only map to one TB; for the downlink TMs {3, 4, 8, 9, 10} and the uplink TM2, one scheduled physical layer data may map to one or two TBs (transport block). A HARQ combination may only be suitable to many physical layer data transmission for one TB.

The inventor researches and discovers that when the UE is configured with one of the downlink TMs {3, 4, 8, 9, 10} or the uplink TM2, if the various physical layer data transmission through the HARQ combination is scheduled by different DCI (downlink control information) formats and a number of the TBs included in the various physical layer data transmission is different, the current information bits in the existing DCI are not able to indicate how to correspond to the TBs included in the various physical layer data transmission.

In view of the above problem, the present invention provides a method and a device for communication by using an unlicensed frequency band.

### SUMMARY

The present invention discloses a method for communication in a user equipment (UE) by using an unlicensed frequency band, which includes the following steps:

Step A: operating a first physical layer data on a first sub frame of a first carrier;

Step B: processing a first HARQ_ACK for the first physical layer data;

Step C: operating a second physical layer data on a second sub frame of a second carrier;

wherein the first physical layer data and the second physical layer data belong to the same one HARQ process. The first physical layer data corresponds to a first TB and a second TB, and the second physical layer data corresponds to the first TB or the second TB. The step of operating and the step of processing are a step of receiving and a step of transmitting respectively, or the step of operating and the step of processing are a step of transmitting and a step of receiving respectively. The first HARQ_ACK indicates that the first TB and the second TB are wrongly transmitted.

In one embodiment, the step of operating is a step of receiving. In another embodiment, the step of operating is a step of transmitting.

Specifically, according to an aspect of the present invention, the step of operating on the first carrier and the step of operating on the second carrier for the UE are respectively configured as a first TM and a second TM, the first TM maximally supports a transmission of two TBs, and the second TM maximally support a transmission of one TB.

In one embodiment, the first TM is one of downlink TMs {3, 4, 8, 9, 10}, and the second TM is one of downlink TMs {1, 2, 5, 6, 7}. In another embodiment, the first TM is an uplink TM2, and the second TM is an uplink TM1.

Specifically, according to an aspect of the present invention, at least one of the first carrier and the second carrier is deployed on the unlicensed spectrum.

In one embodiment, the first carrier is deployed on the unlicensed spectrum, and the second carrier is deployed on a licensed spectrum.

Specifically, according to an aspect of the present invention, the Step C includes the following step:

Step C0: receiving a second signaling, wherein the second signaling schedules the second physical layer data.

Wherein the first sub frame is prior to the second sub frame, and the TB corresponding to the second physical layer data is indicated by the second signaling.

In one embodiment, a format of the second signaling is DCI format 0.

Specifically, according to an aspect of the present invention, the first sub frame is prior to the second sub frame, and the TB corresponding to the second physical layer data is fixed as the first TB.

The character of the above aspect is that the TB corresponding to the second physical layer data is fixed as one of two TBs corresponding to the first physical layer data, so as to determine that a receiver performs a combination of the first physical layer data and the second physical layer data without an explicit indication.

In one embodiment of the above aspect, in a scheduling DCI of the first physical layer data, a redundancy version (RV) of the TB and a RV of the second TB are the same, i.e. the receiver does not determine the TB corresponding to the second physical data according to the RV in a schedule signaling of the second physical layer data.

Specifically, according to the above aspect of the present invention, the Step C further includes the following steps:

Step C1: processing a second HARQ_ACK of the second physical layer data;

Step C2: operating a third physical layer data on a third sub frame of the second carrier.

Wherein if the second HARQ_ACK indicates that the first TB is wrongly received, the third physical layer data corresponds to the first TB; if the second HARQ_ACK indicates that the first TB is correctly received, the third physical data corresponds to the second TB.

In one embodiment, if the TB corresponding to the second physical layer data, i.e. the first TB is wrongly received, the first TB is re-transmitted until the receiving is correct or a maximum re-transmission number is achieved. If the maximum re-transmission number is not achieved after the first TB is correctly received, the second TB is re-transmitted again.

Specifically, according to an aspect of the present invention, the step of operating and the step of processing are respectively a step of receiving and a step of transmitting, the UE blindly determines the TB corresponding to the second physical layer data.

In one embodiment, the blind determination is that: the second physical layer data is combined and coded with the bits in a cache corresponding to the first TB and the bits in a cache corresponding to the second TB, the TB which is correctly coded is the TB corresponding to the second physical layer data. If they are not correctly coded, it waits for the next data re-transmission.

Specifically, according to an aspect of the present invention, the first TB corresponds to a codeword 0.

The present invention discloses a method for communication in a base station by using an unlicensed frequency band, which includes the following steps:

Step A: operating a first physical layer data on a first sub frame of a first carrier;

Step B: processing a first HARQ_ACK for the first physical layer data;

Step C: operating a second physical layer data on a second sub frame of a second carrier;

wherein the first physical layer data and the second physical layer data belong to the same one HARQ process. The first physical layer data corresponds to a first TB and a second TB, and the second physical layer data corresponds to the first TB or the second TB. The step of operating and the step of processing are a step of receiving and a step of transmitting respectively, or the step of operating and the step of processing are a step of transmitting and a step of receiving respectively. The first HARQ_ACK indicates that the first TB and the second TB are wrongly transmitted.

Specifically, according to an aspect of the present invention, the step of operating on the first carrier and the step of operating on the second carrier for a target UE of the HARQ process are respectively configured as a first TM and a second TM, the first TM maximally supports a transmission of two TBs, and the second TM maximally support a transmission of one TB.

Specifically, according to an aspect of the present invention, at least one of the first carrier and the second carrier is deployed on the unlicensed spectrum.

In one embodiment, the first carrier and the second carrier are deployed on the unlicensed spectrum.

Specifically, according to an aspect of the present invention, the Step C includes the following step:

Step C0: transmitting a second signaling, wherein the second signaling schedules the second physical layer data.

Wherein the first sub frame is prior to the second sub frame, and the TB corresponding to the second physical layer data is indicated by the second signaling.

In one embodiment, a format of the second signaling is one of DCI formats {1, 1A, 1B, 1C, 1D}.

Specifically, according to an aspect of the present invention, the first sub frame is prior to the second sub frame, and the TB corresponding to the second physical layer data is fixed as the first TB.

Specifically, according to an above aspect of the present invention, the Step C further includes the following steps:

Step C1: processing a second HARQ_ACK of the second physical layer data;

Step C2: operating a third physical layer data on a third sub frame of the second carrier.

Wherein if the second HARQ_ACK indicates that the first TB is wrongly received, the third physical layer data corresponds to the first TB; if the second HARQ_ACK indicates that the first TB is correctly received, the third physical data corresponds to the second TB.

Specifically, according to an aspect of the present invention, the first TB corresponds to a codeword 0.

The present invention discloses a user equipment, and the UE includes:

a first module, for operating a first physical layer data on a first sub frame of a first carrier;

a second module, for processing a first HARQ_ACK for the first physical layer data;

a third module, for operating a second physical layer data on a second sub frame of a second carrier;

wherein the first physical layer data and the second physical layer data belong to the same one HARQ process. The first physical layer data corresponds to a first TB and a second TB, the second physical layer data corresponds to the first TB or the second TB. The step of operating and the step of processing are a step of receiving and a step of transmitting respectively, or the step of operating and the step of processing are a step of transmitting and a step of receiving respectively. The first HARQ_ACK indicates that the first TB and the second TB are wrongly transmitted.

In one embodiment, the second module is further used for processing a second HARQ_ACK of the second physical layer data; the third module is used for operating a third physical layer data on a third sub frame of the second carrier.

Wherein the first sub frame is prior to the second sub frame, the TB corresponding to the second physical layer data is fixed as the first TB; if the second HARQ_ACK indicates that the first TB is wrongly received, the third physical layer data corresponds to the first TB; if the second HARQ_ACK indicates that the first TB is correctly received, the third physical data corresponds to the second TB.

The present invention discloses a base station equipment, and the base station equipment includes:

a first module, for operating a first physical layer data on a first sub frame of a first carrier;

a second module, for processing a first HARQ_ACK for the first physical layer data;

a third module, for operating a second physical layer data on a second sub frame of a second carrier;

wherein the first physical layer data and the second physical layer data belong to the same one HARQ process. The first physical layer data corresponds to a first TB and a second TB, the second physical layer data corresponds to the first TB or the second TB. The step of operating and the step of processing are a step of receiving and a step of transmitting respectively, or the step of operating and the step of processing are a step of transmitting and a step of receiving respectively. The first HARQ_ACK indicates that the first TB and the second TB are wrongly transmitted.

In one embodiment, the second module is used for processing a second HARQ_ACK of the second physical layer data; the third module is used for operating a third physical layer data on a third sub frame of the second carrier.

Wherein the first sub frame is prior to the second sub frame, the TB corresponding to the second physical layer data is fixed as the first TB, if the second HARQ_ACK indicates that the first TB is wrongly received, the third physical layer data corresponds to the first TB; if the second HARQ_ACK indicates that the first TB is correctly received, the third physical data corresponds to the second TB.

For a problem of the HARQ combination caused by performing the HARQ combination for different numbers of the TBs included in the many physical layer data transmissions, the present invention provides a communication method and device by using an unlicensed frequency band and in one embodiment. In one embodiment, the receiver performs is the HARQ combination for the many physical layer data through a predetermined manner. The solution of the present invention is particularly suitable for a DFS scenario in communication using an unlicensed spectrum. Besides, the present invention is compatible with the existing LTE standards as much as possible and has good compatibility.

### BRIEF DESCRIPTION OF THE DRAWINGS

The above and other exemplary aspects, features and advantages of certain exemplary embodiments of the present invention will be more apparent from the following description taken in conjunction with the accompanying drawings, in which:

FIG. 1 is a flowchart of transmitting a downlink physical layer data according to one embodiment of the present invention;

FIG. 2 is flowchart of re-transmitting a downlink physical layer data according to one embodiment of the present invention;

FIG. 3 is a flowchart of transmitting an uplink physical layer data according to one embodiment of the present invention;

FIG. 4 is a diagram illustrating a time sequence of a transmitting sub frame of a physical layer data according to another embodiment of the present invention;

FIG. 5 is a structure diagram illustrating a receiving apparatus of the physical layer data according to one embodiment of the present invention; and

FIG. 6 is a structure diagram illustrating an emitting apparatus of the physical layer data according to one embodiment of the present invention.

### DETAILED DESCRIPTION

The following description with reference to the accompanying drawings is provided to explain the exemplary embodiments of the invention. Note that in the case of no conflict, the embodiments of the present invention and the features of the embodiments may be arbitrarily combined with each other.

### Embodiment I

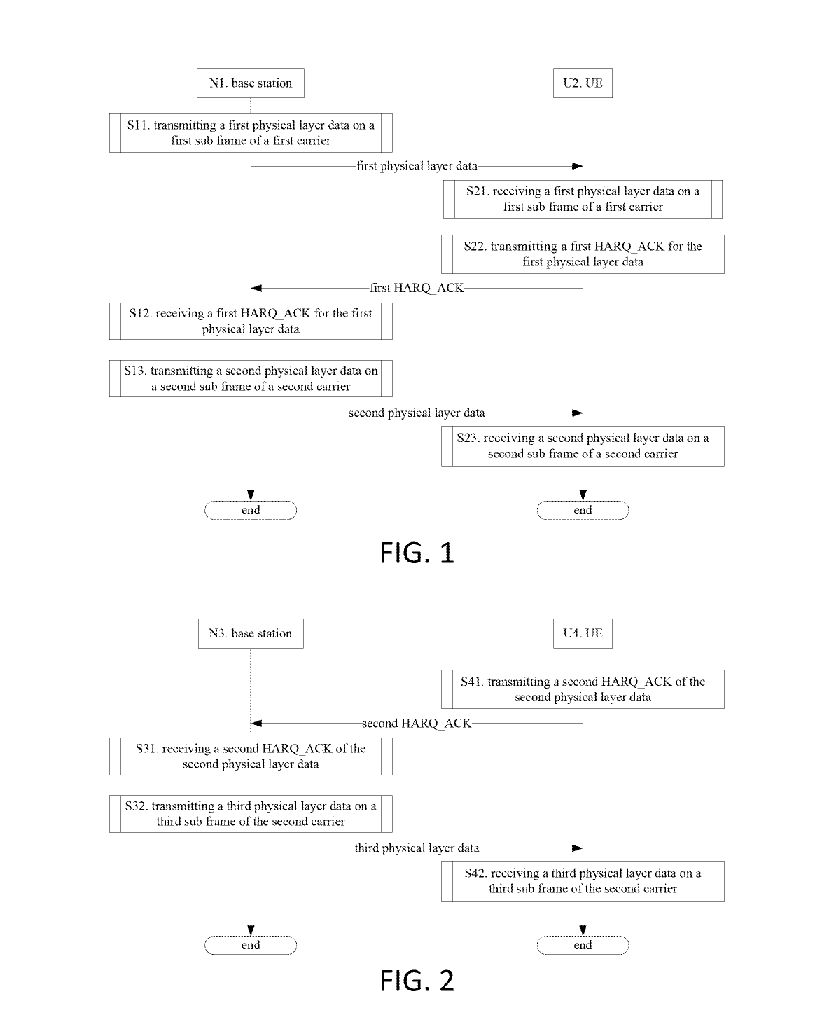

Embodiment I illustrates a flowchart of transmitting a downlink physical layer data, as shown in FIG. 1. In FIG. 1, a base station N1 is a serving base station of a UE U2.

For the base station N1, in step S11, the method involves transmitting a first physical layer data on a first sub frame of a first carrier. In step S12, the method involves receiving a first HARQ_ACK for the first physical layer data. In step S13, the method involves transmitting a second physical layer data on a second sub frame of a second carrier.

For the UE U2, in step S21, the method involves receiving a first physical layer data on a first sub frame of a first carrier. In step S22, the method involves transmitting a first HARQ_ACK for the first physical layer data. In step S23, the method involves receiving a second physical layer data on a second sub frame of a second carrier.

In Embodiment I, the first physical layer data and the second physical layer data belong to the same one HARQ process. The first physical layer data corresponds to a first TB and a second TB, and the second physical layer data corresponds to the first TB or the second TB. The first HARQ_ACK indicates that the first TB and the second TB are wrongly transmitted.

In a first exemplary embodiment of Embodiment I, the base station N1 configures the receiving of a physical downlink shared channel (PDSCH) on the first carrier and the receiving of the PDSCH on the second carrier for the UE U2 as a first TM and a second TM, the first TM maximally supports a transmission of two TBs, and the second TM maximally support a transmission of one TB. The first carrier is deployed on the unlicensed spectrum, and the second carrier is deployed on a licensed spectrum.

In a second exemplary embodiment of Embodiment I, the first sub frame is prior to the second sub frame, and the TB corresponding to the second physical layer data is fixed as the first TB.

In a third exemplary embodiment of Embodiment I, the first TB corresponds to a codeword 0.

In a fourth exemplary embodiment of Embodiment I, the UE blindly determines the TB corresponding to the second physical layer data.

### Embodiment II

Embodiment II is a flowchart of re-transmitting a physical layer data, as shown in FIG. 2. In FIG. 2, a base station N3 is a serving base station of a UE U4.

For the base station N3, in step S31, the method involves receiving a second HARQ_ACK of the second physical layer data; in step S32, the method involves transmitting a third physical layer data on a third sub frame of the second carrier.

For the UE U4, in step S41, the method involves transmitting a second HARQ_ACK of the second physical layer data; in step S42, the method involves receiving a third physical layer data on a third sub frame of the second carrier.

In Embodiment II, if the second HARQ_ACK indicates that the first TB is wrongly received, the third physical layer data corresponds to the first TB; if the second HARQ_ACK indicates that the first TB is correctly received, the third physical data corresponds to the second TB. The first TB and the second TB are two TBs corresponding to the first physical layer data, and the first physical layer data is transmitted to the UE U2 from the base station N3 before the second physical layer data is transmitted.

In a first exemplary embodiment of Embodiment II, if the second HARQ_ACK indicates that the first TB is wrongly received, the base station N3 re-transmits the first TB until the first TB is correctly received or the maximum re-transmission number is achieved.

### Embodiment III

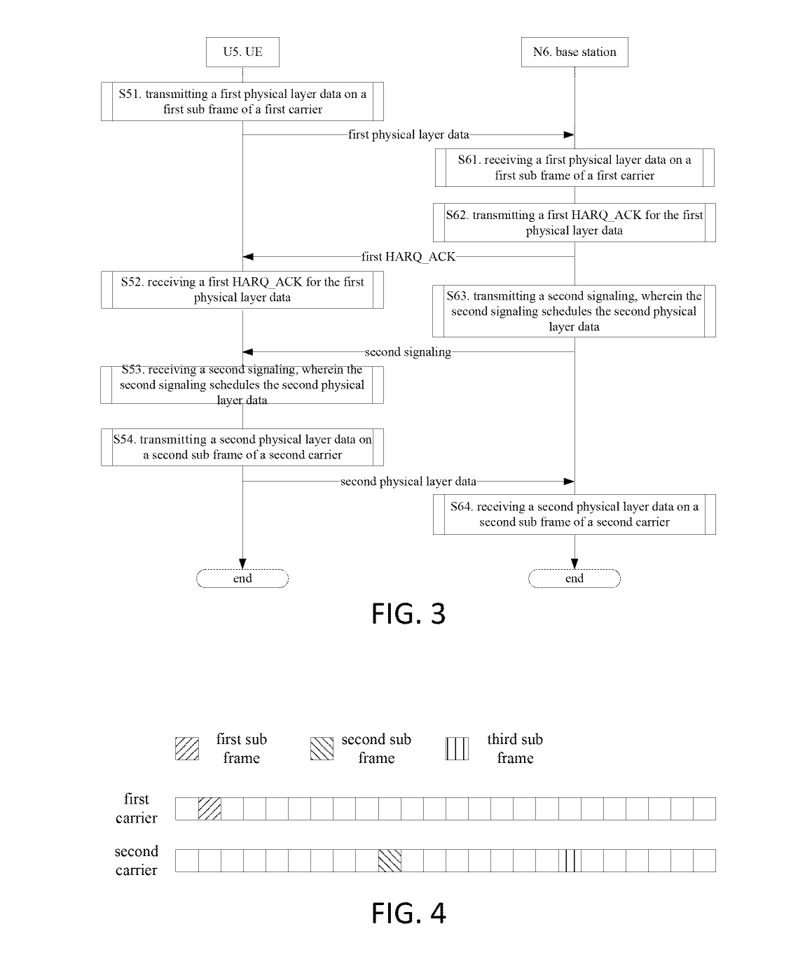

Embodiment III is a flowchart of transmitting an uplink physical layer data, as shown in FIG. 3. In FIG. 3, a base station is a serving base station of a UE U5.

For the UE U5, in step S51, the method involves transmitting a first physical layer data on a first sub frame of a first carrier; in step S52, the method involves receiving a first HARQ_ACK for the first physical layer data; in step S53, the method involves receiving a second signaling, wherein the second signaling schedules the second physical layer data; in step S54, the method involves transmitting a second physical layer data on a second sub frame of a second carrier.

For the base station N6, in step S61, the method involves receiving a first physical layer data on a first sub frame of a first carrier; in step S62, the method involves transmitting a first HARQ_ACK for the first physical layer data; in step S63, the method involves transmitting a second signaling, wherein the second signaling schedules the second physical layer data; in step S64, the method involves receiving a second physical layer data on a second sub frame of a second carrier.

In Embodiment III, the first physical layer data and the second physical layer data belong to the same one HARQ process. The first physical layer data corresponds to a first TB and a second TB, the second physical layer data corresponds to the first TB or the second TB. The first HARQ_ACK indicates that the first TB and the second TB are wrongly transmitted. The first sub frame is prior to the second sub frame, and the TB corresponding to the second physical layer data is indicated by the second signaling.

In a first exemplary embodiment of Embodiment III, one bit of the second signaling explicitly indicates that the TB scheduled by the second signaling is the first TB or the second TB.

In a second exemplary embodiment of Embodiment III, a format of the second signaling is a DCI format 0.

### Embodiment IV

Embodiment IV is a diagram illustrating a time sequence of a transmitting sub frame of a physical layer data, as shown in FIG. 4. In FIG. 4, a square identified by a slash is a first sub frame, a square identified by a backslash is a second sub frame, and a square identified by a vertical line is a third sub frame.

For the UE, firstly, a first physical layer data is operated on a first sub frame of a first carrier; a first HARQ_ACK for the first physical layer data is processed; a second physical layer data is operated on a second sub frame of a second carrier; processing a second HARQ_ACK of the second physical layer data; a third physical layer data is operated on a third sub frame of the second carrier.

For the base station, firstly, a first physical layer data is processed on a first sub frame of a first carrier; a first HARQ_ACK for the first physical layer data is operated; a second physical layer data is processed on a second sub frame of a second carrier; the operating is used for a second HARQ_ACK of the second physical layer data; a third physical layer data is processed on a third sub frame of the second carrier.

In Embodiment IV, the first physical layer data and the second physical layer data belong to the same one HARQ process. The first physical layer data corresponds to a first TB and a second TB, the second physical layer data corresponds to the first TB or the second TB. The step of operating and the step of processing are a step of receiving and a step of transmitting respectively, or the step of operating and the step of processing are a step of transmitting and a step of receiving respectively. The first HARQ_ACK indicates that the first TB and the second TB are wrongly transmitted. If the second HARQ_ACK indicates that the first TB is wrongly received, the third physical layer data corresponds to the first TB; if the second HARQ_ACK indicates that the first TB is correctly received, the third physical data corresponds to the second TB. The second sub frame is an eighth sub frame behind the first sub frame, and the third sub frame is an eighth sub frame behind the second sub frame. At least one of the first carrier and the second carrier is deployed on the unlicensed spectrum.

### Embodiment V

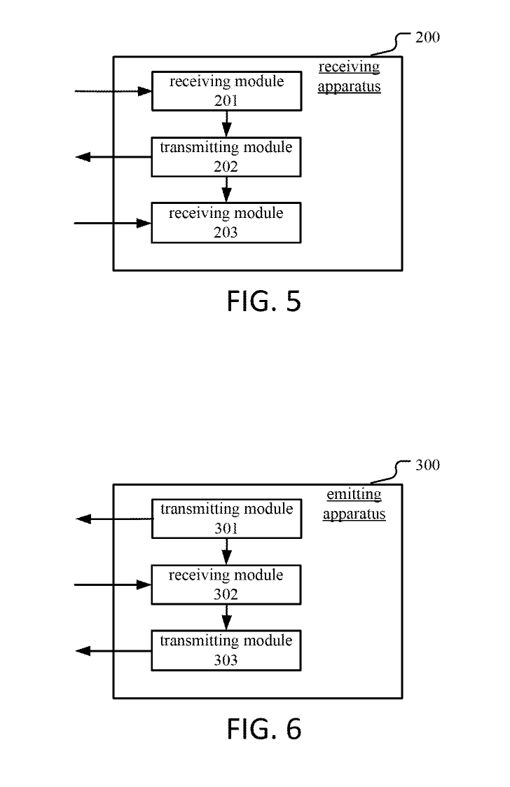

Embodiment V is a structure diagram illustrating a receiving apparatus of the physical layer data, as shown in FIG. 5. In FIG. 5, the receiving apparatus 200 mainly includes a first receiving module 201, a first transmitting module 202, and a second receiving module 203. The receiving apparatus is configured in the UE or the base station.

The receiving module 201 is used for receiving a first physical layer data on a first sub frame of a first carrier; the first transmitting module 202 is used for processing a first HARQ_ACK for the first physical layer data; the second receiving module 203 is used for operating a second physical layer data on a second sub frame of a second carrier.

In Embodiment V, the first physical layer data and the second physical layer data belong to the same one HARQ process. The first physical layer data corresponds to a first TB and a second TB, the second physical layer data corresponds to the first TB or the second TB. The first HARQ_ACK indicates that the first TB and the second TB are wrongly transmitted.

In a first exemplary embodiment of Embodiment V, the receiving apparatus 200 is configured in the UE, and the physical layer data is transmitted on the PDSCH.

In a second exemplary embodiment of Embodiment V, the receiving apparatus 200 is configured in the base station, and the physical layer data is transmitted on a physical uplink share channel (PUSCH).

In a third exemplary embodiment of Embodiment V, the first transmitting module 202 is further used for processing a second HARQ_ACK of the second physical layer data; the second receiving module 203 is used for receiving a third physical layer data on a third sub frame of the second carrier. Wherein the first sub frame is prior to the second sub frame, the TB corresponding to the second physical layer data is fixed as the first TB, if the second HARQ_ACK indicates that the first TB is wrongly received, the third physical layer data corresponds to the first TB; if the second HARQ_ACK indicates that the first TB is correctly received, the third physical data corresponds to the second TB.

### Embodiment VI

Embodiment VI is a structure diagram illustrating an emitting apparatus of the physical layer data, as shown in FIG. 6. In FIG. 6, the emitting apparatus 300 mainly includes a second transmitting module 301, a third receiving module 302 and a third transmitting module 303. The emitting apparatus 300 is configured in the UE or the base station.

The second transmitting module 301 is used for transmitting a first physical layer data on a first sub frame of a first carrier; the third receiving module 302 is used for receiving a first HARQ_ACK for the first physical layer data; the third transmitting module 303 is used for transmitting a second physical layer data on a second sub frame of a second carrier.

In Embodiment VI, the first physical layer data and the second physical layer data belong to the same one HARQ process. The first physical layer data corresponds to a first TB and a second TB, the second physical layer data corresponds to the first TB or the second TB. The step of operating and the step of processing are a step of receiving and a step of transmitting respectively, or the step of operating and the step of processing are a step of transmitting and a step of receiving respectively. The first HARQ_ACK indicates that the first TB and the second TB are wrongly transmitted.

In a first exemplary embodiment of Embodiment VI, the emitting apparatus 300 is configured in the UE, the physical layer data is transmitted on the PUSCH.

In a second exemplary embodiment of Embodiment VI, the emitting apparatus 300 is configured in the base station, the physical layer data is transmitted on the PDSCH.

In a third exemplary embodiment of Embodiment VI, the third receiving module 302 is further used for receiving a second HARQ_ACK of the second physical layer data; the third transmitting module 303 is further used for transmitting a third physical layer data on a third sub frame of the second carrier. Wherein the first sub frame is prior to the second sub frame, the TB corresponding to the second physical layer data is fixed as the first TB if the second HARQ_ACK indicates that the first TB is wrongly received, the third physical layer data corresponds to the first TB; if the second HARQ_ACK indicates that the first TB is correctly received, the third physical data corresponds to the second TB.

Those of ordinary skill will be appreciated that all or part of the above method may be accomplished by a program instructing related hardware. The program may be stored in a computer-readable storage medium, such as read-only memory, a hard disk or CD-ROM. Alternatively, all or part of the steps of the above-described embodiments may be accomplished by one or more integrated circuits. Accordingly, each module in the above-described embodiments may be accomplished by hardware implementation, or may also be realized by the form of software modules. The present invention is not limited to any particular form of combination of software and hardware.

Although the present invention is illustrated and described with reference to specific embodiments, those skilled in the art will understand that many variations and modifications are readily attainable without departing from the spirit and scope thereof as defined by the appended claims and their legal equivalents.

1. A method for communication in a UE by using an unlicensed frequency band, comprising:
Step A: operating a first physical layer data on a first sub frame of a first carrier;
Step B: processing a first HARQ_ACK for the first physical layer data;
Step C: operating a second physical layer data on a second sub frame of a second carrier;
wherein the first physical layer data and the second physical layer data belong to the same one HARQ process; the first physical layer data corresponds to a first TB and a second TB, the second physical layer data corresponds to the first TB or the second TB; the step of operating and the step of processing are a step of receiving and a step of transmitting respectively, or the step of operating and the step of processing are a step of transmitting and a step of receiving respectively; the first HARQ_ACK indicates that the first TB and the second TB are wrongly transmitted.

2. The method for communication in the UE by using the unlicensed frequency band according to claim 1, wherein the step of operating on the first carrier and the step of operating on the second carrier for the UE are respectively configured as a first TM and a second TM, the first TM maximally supports a transmission of two TBs, and the second TM maximally support a transmission of one TB.

3. The method for communication in the UE by using the unlicensed frequency band according to claim 1, wherein at least one of the first carrier and the second carrier is deployed on the unlicensed spectrum, or the first TB corresponds to a codeword 0, or the first sub frame is prior to the second sub frame, the TB corresponding to the second physical layer data is fixed as the first TB.

4. The method for communication in the UE by using the unlicensed frequency band according to claim 1, wherein the Step C comprises the following step:
Step C0: receiving a second signaling, wherein the second signaling schedules the second physical layer data;
wherein the first sub frame is prior to the second sub frame, and the TB corresponding to the second physical layer data is indicated by the second signaling.

5. (canceled)

6. The method for communication in the UE by using the unlicensed frequency band according to claim 1, wherein the step of operating and the step of processing respectively are a step of receiving and a step of transmitting, the UE blindly determines the TB corresponding to the second physical layer data.

7. The method for communication in the UE by using the unlicensed frequency band according to claim 1, wherein the Step C further comprises the following steps:
Step C1: processing a second HARQ_ACK of the second physical layer data;
Step C2: operating a third physical layer data on a third sub frame of the second carrier;
wherein if the second HARQ_ACK indicates that the first TB is wrongly received, the third physical layer data corresponds to the first TB; if the second HARQ_ACK indicates that the first TB is correctly received, the third physical data corresponds to the second TB.

8. (canceled)

9. A method for communication in a base station by using an unlicensed frequency band, comprising:
Step A: operating a first physical layer data on a first sub frame of a first carrier;
Step B: processing a first HARQ_ACK for the first physical layer data;
Step C: operating a second physical layer data on a second sub frame of a second carrier;
wherein the first physical layer data and the second physical layer data belong to the same one HARQ process; the first physical layer data corresponds to a first TB and a second TB, the second physical layer data corresponds to the first TB or the second TB; the step of operating and the step of processing are a step of receiving and a step of transmitting respectively, or the step of operating and the step of processing are a step of transmitting and a step of receiving respectively; the first HARQ_ACK indicates that the first TB and the second TB are wrongly transmitted.

10. The method for communication in the base station by using the unlicensed frequency band according to claim 9, wherein the step of operating on the first carrier and the step of operating on the second carrier for a target UE of the HARQ process are respectively configured as a first TM and a second TM, the first TM maximally supports a transmission of two TBs, and the second TM maximally support a transmission of one TB.

11. The method for communication in the base station by using the unlicensed frequency band according to claim 9, wherein at least one of the first carrier and the second carrier is deployed on the unlicensed spectrum, or the first TB corresponds to a codeword 0, or the first sub frame is prior to the second sub frame, the TB corresponding to the second physical layer data is fixed as the first TB.

12. The method for communication in the base station by using the unlicensed frequency band according to claim 9, wherein the Step C comprises the following step:
Step C0: transmitting a second signaling, wherein the second signaling schedules the second physical layer data;
wherein the first sub frame is prior to the second sub frame, and the TB corresponding to the second physical layer data is indicated by the second signaling.

13. (canceled)

14. The method for communication in the base station by using the unlicensed frequency band according to claim 9, wherein the Step C further comprises the following steps:
Step C1: processing a second HARQ_ACK of the second physical layer data;
Step C2: operating a third physical layer data on a third sub frame of the second carrier;
wherein if the second HARQ_ACK indicates that the first TB is wrongly received, the third physical layer data corresponds to the first TB; if the second HARQ_ACK indicates that the first TB is correctly received, the third physical data corresponds to the second TB.

15. (canceled)

16. A user equipment, wherein the UE comprises:
a first module, for operating a first physical layer data on a first sub frame of a first carrier;
a second module, for processing a first HARQ_ACK for the first physical layer data;
a third module, for operating a second physical layer data on a second sub frame of a second carrier;
wherein the first physical layer data and the second physical layer data belong to the same one HARQ process; the first physical layer data corresponds to a first TB and a second TB, the second physical layer data corresponds to the first TB or the second TB; the step of operating and the step of processing are a step of receiving and a step of transmitting respectively, or the step of operating and the step of processing are a step of transmitting and a step of receiving respectively; the first HARQ_ACK indicates that the first TB and the second TB are wrongly transmitted.

17. The user equipment according to claim 16, wherein the second module is further used for processing a second HARQ_ACK of the second physical layer data; the third module is used for operating a third physical layer data on a third sub frame of the second carrier;
wherein the first sub frame is prior to the second sub frame, the TB corresponding to the second physical layer data is fixed as the first TB, if the second HARQ_ACK indicates that the first TB is wrongly received, the third physical layer data corresponds to the first TB; if the second HARQ_ACK indicates that the first TB is correctly received, the third physical data corresponds to the second TB.

18. A base station equipment, wherein the base station equipment comprises:
a first module, for operating a first physical layer data on a first sub frame of a first carrier;
a second module, for processing a first HARQ_ACK for the first physical layer data;
a third module, for operating a second physical layer data on a second sub frame of a second carrier;
wherein the first physical layer data and the second physical layer data belong to the same one HARQ process; the first physical layer data corresponds to a first TB and a second TB, the second physical layer data corresponds to the first TB or the second TB; the step of operating and the step of processing are a step of receiving and a step of transmitting respectively, or the step of operating and the step of processing are a step of transmitting and a step of receiving respectively; the first HARQ_ACK indicates that the first TB and the second TB are wrongly transmitted.

19. The base station equipment according to claim 18, wherein the second module is further used for processing a second HARQ_ACK of the second physical layer data; the third module is further used for operating a third physical layer data on a third sub frame of the second carrier;
wherein the first sub frame is prior to the second sub frame, the TB corresponding to the second physical layer data is fixed as the first TB, if the second HARQ_ACK indicates that the first TB is wrongly received, the third physical layer data corresponds to the first TB; if the second HARQ_ACK indicates that the first TB is correctly received, the third physical data corresponds to the second TB.
